(19) United States
(12) Patent Application Publication
(10) Pub. No.: US 2006/0184400 A1
(43) Pub. Date: Aug. 17, 2006

(54) System and method for real-time pricing through advertising

(75) Inventors: Bejugum V. Rao, Flower Mound, TX (US); Robert F. Schermerhorn, Argyle, TX (US); Barry C. Smith, Flower Mound, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc.

(21) Appl. No.: 11/059,883

(22) Filed: Feb. 17, 2005

(51) Int. Cl. G01C 21/34; G01C 21/36

(52) U.S. Cl. 705/6

(57) ABSTRACT

A method, system, and computer-readable medium for providing real-time pricing through advertising are provided. The method includes generating at least one search result satisfying a user request and generating a visit parameter set in response to the request. The method also includes augmenting the visit parameter set with at least one target parameter extracted from the search result to create an augmented visit parameter set. The method further includes providing at least one target-able ad that is selected based on the augmented visit parameter set.

### BACKGROUND OF THE INVENTION

1) Field of the Invention

The present invention relates to real-time pricing through advertising and, more particularly, to a system and method for market-based and real-time pricing through dynamic ad serving.

2) Description of Related Art

Statistics show that having at least two options, each having a lowest associated fare, results in a higher session-to-book conversion than if only one lowest fare option were given. The increase in conversion occurs until a given number of lowest fare instances are displayed. After the given number is reached, the impact of additional lowest fare options typically does not occur. Generally, the increase in conversion results for various advance purchase windows (i.e., 0-6 days, 7-20 days, and 21+ days).

In addition, knowledge of the conversion rate may be used to provide additional value to suppliers. For instance, airlines attempt to match, come close to, or beat the lowest fare in the market to present the consumer with additional options to choose from, which is in effect, real-time market pricing of tickets. However, although airlines may present additional options to the consumers, airlines are not very successful in real-time market pricing given the variations due to availability and the method in which low fare search algorithms construct itineraries.

A common way to present consumers with additional options is through advertising. For example, when a consumer enters a search request for goods or services, the consumer is presented not only with search results satisfying the request, but also an advertisement, where the advertisement solicits the consumer to purchase similar or competitive goods or services from the advertiser. Further, Internet websites typically sell advertising space to advertisers, where a user accessing a website will also receive an embedded advertisement. In particular, banner ads or pop-up ads are frequently utilized on Internet for targeted advertising. Ads may be customized for a user with information collected from the user based on the user's activity, profile, or demographics. Advertisers are willing to spend various amounts for a particular ad depending on the cost-per-thousand (CPM) or cost-per-click (CPC) value associated with the ad. Airlines attempt to match, come close to, or beat the lowest fare in the market, which is in effect, real-time market pricing of tickets. However, airlines do not have access to real-time marketplace fares and availability to accomplish the fare changes in real time.

Targeted advertising typically includes the customer making a shopping or connect request on a browser maintained by a service provider (i.e., site visit). A web server receives the request and generates a list of potential options satisfying the customer's request, such as travel itineraries. The itineraries are rendered by the browser so that the customer may view a web page displaying the itineraries. The web page includes a HTML redirect to ad server that allows the ad server to access site visit parameters through the redirect link, where the redirect is a call to an ad server incorporated in the HTML source code sent to the browser by the web server. The browser typically makes the call over Internet, and the ad server responds with an ad to be rendered in the browser. In particular, these parameters are used for targeted advertising. The ad server selects an appropriate ad from potential target ads that can be employed to target market to the customer based on information gleaned from the site visit. The ad is rendered by the browser so that the ad is displayed to the customer along with the search results. Clicking on the ad directs the customer to a private booking page where suppliers can sell at an appropriate price.

However, the ads are not capable of generating an itinerary having an associated fare in real time and, therefore, the customer is required to perform additional inquiries before the customer may determine comparable itineraries and continue to booking. In addition, although the ads are targeted for the customer based on site visit parameters, the ads are incapable of generating itineraries satisfying additional dynamic criteria, such as a lowest fare in the search results. As such, the customer is not presented with further lowest fare itineraries, which potentially leads to fewer session-to-book conversions.

It would therefore be advantageous to provide a method and system that is capable of generating targeted advertisements having associated fares therewith. It would further be advantageous to provide for a method and system that is capable of generating targeted advertisements in such a manner as to increase the probability of a session-to-book conversion. It would also be advantageous to provide a method and system that is capable of conveniently presenting the targeted advertisements to a customer.

### BRIEF SUMMARY OF THE INVENTION

The invention addresses the above needs and achieves other advantages by providing a method for pricing through advertising, as well as an associated system and computer-readable medium. The method includes generating target-based ads including at least one offer that is presented to the user along with the original search results from the user's request. With respect to the travel industry, the target-based ad includes a set of campaigns having one or more offers for comparable or lower fares for a requested itinerary when compared to the fares returned with the original search results. Thus, the user is presented with more low fare options that increase the probability of a higher session-to-book conversion.

In one embodiment of the present invention, a method for providing pricing through advertising is provided. The method includes generating at least one search result satisfying a user request and generating a visit parameter set in response to the request. The visit parameter set could include a plurality of session-based target parameters and/or a plurality of customer-based target parameters. The method also includes augmenting the visit parameter set with at least one target parameter extracted from the search result to create an augmented visit parameter set. The method further includes providing at least one target-able ad that is selected based on the augmented visit parameter set. In one embodiment, a computer-readable medium containing instructions may be constructed for causing a computer to perform the method.

In various aspects of the present invention, the method includes receiving a request including at least one travel preference, wherein the travel preference includes at least one of departure and return dates, an origin location, a destination location, and a price range. The at least one target parameter may include at least one of a lowest fare, number of lowest fare instances, carriers offering the lowest fare, origin and destination, requested departure time and date, requested arrival time and date, displacement times of the lowest fares, service quality of the lowest fare product (e.g., number of stops, aircraft type), and elapsed time of the lowest fares. The method may include constructing a redirect command including the augmented visit parameter set. The method may also include providing the redirect command along with the augmented visit parameter set, executing the redirect command, determining the at least one target-able ad based on the augmented visit parameter set, and providing the target-able ad along with the search result.

In additional aspects of the method, each search result includes an associated fare, and the target-able ad comprises a set of campaigns with each campaign including one or more offers. The set of campaigns may include at least one offer having a lower or equal associated fare than the associated fare of the search result.

The present invention may also be embodied in a system for providing pricing through advertising. The system includes a client device to receive a user request. The system also includes at least one processing element to generate at least one search result satisfying the request, extract at least one target parameter from the search result, generate a visit parameter set in response to the request, and augment the visit parameter set with the target parameter from the search result to create an augmented visit parameter set. The system further includes an ad server to receive the augmented visit parameter set, determine at least one target-able ad based on the augmented visit parameter set, and transmit the target-able ad to be displayed at the client device.

In various aspects of the system, the system includes at least one server to generate the at least one search result satisfying the request and extract the at least one target parameter from the search result. The processing element could also include a browser element to generate the visit parameter set in response to the request and augment the visit parameter set with the target parameter into an augmented visit parameter set. In one embodiment of the system, the processing element includes a first server to generate the at least one search result satisfying the request, and a second server to extract the at least one target parameter from the search result. The system could also include a campaign database having at least one offer, wherein the ad server is capable of accessing the campaign database to obtain at least one offer to include in the target-able ad.

Another aspect of the present invention includes a method for providing fares for travel through targeted advertising. The method includes generating at least one search result having an associated fare and satisfying a user request. The method also includes generating a visit parameter set in response to the request, and augmenting the visit parameter set with at least one target parameter extracted from the search result to create an augmented visit parameter set. The method further includes providing at least one offer having an associated fare that is selected based on the augmented visit parameter set. In additional aspects of the method, the method includes providing the offer in at one least target-able ad along with the search result. The search result and offer could include at least one respective travel itinerary. In one embodiment of the present invention, the associated fare of the offer is lower than or equal to the associated fare of the search result.

The present invention also provides an apparatus for providing fares for pricing through advertising. The apparatus includes at least one processing element to generate at least one search result satisfying a user request, extract at least one target parameter from the search result that defines at least one characteristic of the search result, and then construct a redirect command to facilitate subsequent generation of an ad based on the characteristic defined by the target parameter. In one aspect of the apparatus, the processing element includes a first server to generate the at least one search result satisfying the request, and construct the redirect command to facilitate subsequent generation of the ad based on the characteristic defined by the target parameter. The processing element could also include a second server to extract the at least one target parameter from the search result that defines the at least one characteristic of the search result.

The present invention provides an additional method for pricing through advertising that includes generating at least one search result satisfying a user request, extracting at least one target parameter from the search result that defines at least one characteristic of the search result, and constructing a redirect command to facilitate subsequent generation of an ad based on the characteristic defined by the target parameter. The method could include providing the redirect command along with the search result, and executing the redirect command.

In another aspect of the present invention, an apparatus for providing pricing through advertising includes a processing element to receive a visit parameter set augmented with at least one target parameter, determine at least one offer having an associated price based on the augmented visit parameter set including the target parameter, and provide the offer in at least one target-able ad. In one aspect of the apparatus, the apparatus also includes a campaign database including the at least one offer, wherein the ad server is capable of accessing the campaign database to obtain the at least one offer to include in the target-able ad to be rendered in the browser. The processing element could be an ad server, while the price could be a fare associated with a travel itinerary.

Moreover, the present invention provides a method for providing fares for pricing through advertising that includes receiving a visit parameter set augmented with at least one target parameter, determining at least one offer having an associated price (e.g., a fare that is associated with a travel itinerary) based on the augmented visit parameter set including the target parameter, and providing the offer in at least one target-able ad.

The present invention therefore provides a method, system, and computer-readable medium that is capable of generating target-based ads that include campaigns that are competitive with the options returned from the original search results. With respect to the airline industry, for example, the campaigns could be regularly loaded into the campaign database, where the target-able ads include campaigns having lower or equally low fares for flights by partner airlines. The lower fares could be a sale fare of an itinerary or airline presented with the original search results and/or an itinerary or airline having a competitive or lower fare from the target-able ads. In this regard, the fares included in the target-based ads may be generated dynamically and in real-time such that the user is presented with additional options satisfying the user's travel preferences. Because the user is presented with more low fare options, there is an increased probability of session-to-book conversion.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a pictorial diagram illustrating a client-server network, according to one embodiment of the present invention;

FIG. 2 is a block diagram illustrating a system for real-time pricing of fares through advertising, according to one embodiment of the present invention;

FIG. 3 is a block diagram illustrating additional detail of the block diagram shown in FIG. 2; and

FIG. 4 is a flowchart illustrating a method for providing real-time pricing through advertising, according to one embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

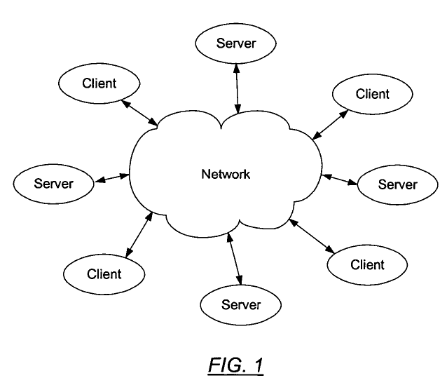

Referring now to the drawings and, in particular to FIG. 1, there is shown a system for communicating through a network. The system generally includes a client-server system interconnected through a network. The system is applicable to any number of travel or other industries, such as airline, hotel, automobile, cruise, bus, or train. Although the concepts of the embodiments of the invention are explained below in connection with travel products and services, they are not limited to such products and services. Therefore, the general approach could be extensible to any number of goods and/or services that can be purchased through the system shown in FIG. 1 (e.g., computer hardware and software, CDs, automobiles, insurance, mortgages, retail goods, etc.).

As referred to herein, the terms “client” and “server” are generally used to refer to a computer's role as a requester of data (i.e., the client) and a provider of data (i.e., the server). The client and server may communicate via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet, an extranet, or any other suitable network. As also used herein, the term “client device” corresponds to any suitable computing device, typically a computer, a personal data assistant, mobile phone, or the like, capable of communicating with a server. Likewise, the server is generally comprised of a computing device having at least one or more processors and associated memory device(s) as known to those skilled in the art. The client device and server may comprise any number of conventional components but typically includes a bus, central processing unit (CPU), read-only memory (ROM), random access memory (RAM), storage device, input/output controller, network interface, and programs having software, as all known to those skilled in the art. Any number of client devices and servers may be included in the system and in communication with one another.

In a web environment, web browsers reside in clients, and specially formatted “web documents” reside on and/or are constructed by web servers. In operation, a browser opens a connection to a server and initiates a request for a document. Typical examples of “browsers” include Netscape Navigator® by Netscape Corportion, Internet Explorer® by Microsoft Corporation, and Opera® by Opera Software A/S. The server delivers the requested document, typically in the form dictated by a standard such as the “HyperText Markup Language” (HTML) format. After the document is delivered, the connection is closed. The browser displays the document or performs a function designated by the document.

The documents delivered in accordance with the present invention include advertisements, as described below. As used herein the terms “advertisement” or “ad” are not meant to be limiting. The terms advertisement or ad could be a promotional communication between a seller offering goods or services to a prospective purchaser of such goods or services. In addition, the advertisement or ad could contain any type or amount of data that is capable of being communicated for the purpose of generating interest in or sale of goods or services. For instance, each advertisement or ad may include one or more “campaigns,” where the campaign corresponds to a particular offering for goods or services. Furthermore, each campaign includes one or more offers having an associated price, where each offer may be presented in an advertisement. The advertisement or ad could be communicated in various forms, such as with image or textual data. Thus, the advertisement or ad could include, for example, graphical information about a product or service, a coupon, or any other commercial information (and may also include text, animation, video, audio, and/or executable information). Examples of graphical advertisements include banner advertisements, interstitial advertisements (e.g., pop-up or pop-under), and hyperstitial advertisements (e.g., “full-page” advertisements).

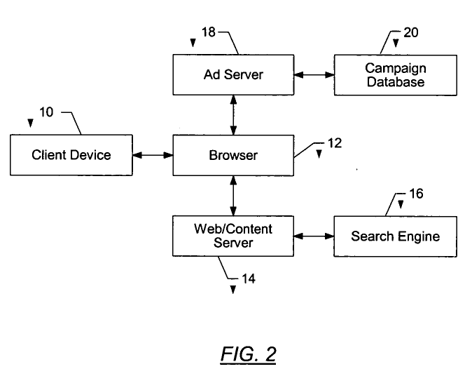

FIG. 2 illustrates a system for providing market-based and real-time pricing through advertising according to one embodiment of the present invention. In particular, a user utilizing a client device 10 may employ a browser 12 to access a web/content server 14 over Internet. The server 14 may thus include a web server, which sends content to the browser 12, as well as a content server that assembles the content for the web server. The web/content server 14 may obtain information from a search engine 16, while an ad server 18 may obtain information from a campaign database 20 and transmit the information to the browser 12.

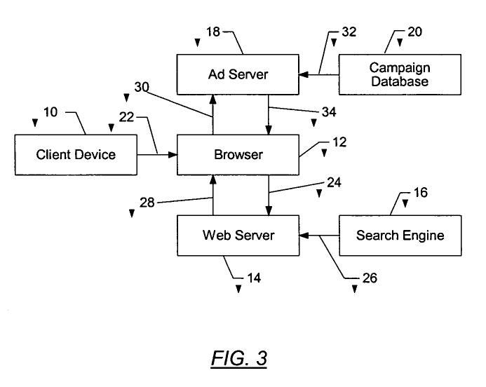

The general flow of information is depicted by FIG. 3, where a user accesses the client device 10 and visits a browser 12 (arrow 22) to make a request (arrow 24). In response to the request, the web/content server 14 employs a search engine 16 to generate search results satisfying the request (arrow 26). The web/content server 14 then prepares a web page containing the search results and provides the web page to the browser 12 (arrow 28). The web page contains a redirect command, such as HTML redirect to the ad server 18, where parameters associated with the user and the user's request are sent to, and received by, the ad server 18 (arrow 30). The redirect is a call to the ad server 18 incorporated in the HTML source code sent to the browser 12 by the web/content server 14, where the browser typically makes the call over Internet. The ad server 18 accesses a campaign database 20 that generates one or more targeted offers (arrow 32). In turn, the ad server 18 communicates a target-based ad having one or more offers to the browser 12 (arrow 34) such that the offers are displayed or otherwise accessible by the client device 10 via the browser 12. The web page could be supplemented with the target-based ad (i.e., returned along with the search results) or included on the web page after the original search results have been presented to the user.

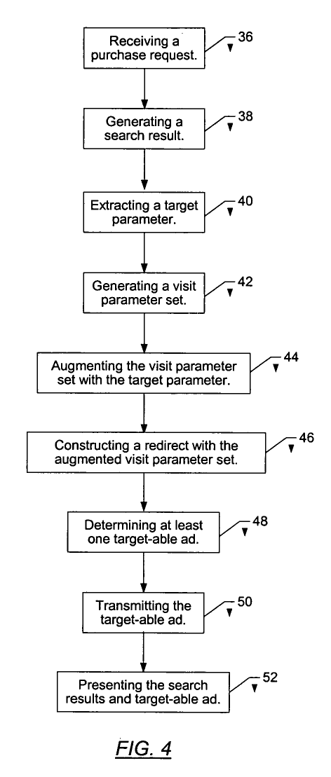

FIG. 4 illustrates a flowchart that more specifically outlines the process of providing market-based and real-time pricing through advertising according to one embodiment of the present invention. The purchase request is received (block 36) at the browser 12 and typically includes a request for a particular item or service, keyword, and/or price. Moreover, with respect to travel, the travel request typically includes one or more travel preferences, such as departure and return dates, an origin location, a destination location, and price range.

A computerized reservation service, such as Travelocity.com, having a web/content 14 server and an associated search engine 16 could be utilized to process a user's search request and generate search results satisfying the user's request. The search engine 16 typically generates at least one search result satisfying the request (block 38). Thus, the search engine 16 could generate one or more travel itineraries satisfying the travel preferences specified in the request, where each travel itinerary has an associated fare. The search engine 16 could be any suitable search engine utilizing various techniques and algorithms for generating the search results satisfying the user's request.

According to the present invention, the web page generated by the web/content server 14 and provided to the browser 12 contains a redirect command that not only provides instructions for redirection but also an augmented visit parameter set, as will be explained below. Target parameters are placed in the HTML code for augmenting the visit parameter set. In another embodiment of the present invention, the redirect could also contain several target parameters. The target parameters could include one or more of a lowest fare, number of lowest fare instances, carriers offering the lowest fare, origin and destination, requested departure time and date, requested arrival time and date, displacement times of the lowest fares, service quality of the lowest fare product (e.g., number of stops, aircraft type), or elapsed time of the lowest fares. Thus, the target parameter could be a characteristic of the search result. The redirect could be provided along with the search result such that one or more target parameters may be extracted from the search result. A process residing on the web/content server 14 (e.g., a first server) or a separate second server is used to extract one or more of the target parameters from the search results (block 40). The redirect could be subsequently modified with the augmented visit parameter set to facilitate generation of a target-able ad.

Moreover, a visit parameter set is generated (block 42) that generally includes various session-based and customer-based targeting parameters. The visit parameter set could be generated by the browser 12, web/content server 14, or an additional server based on the user's current and/or previous site visits. For instance, the session-based target parameters could include, for example, information related to the user's request or particular web pages the user previously visited (e.g., the client's shopping behavior), while the customer-based target parameters would typically relate to the user's particular demographics. The demographics data can be obtained from a database matching the customer's ID. The customer ID would be self-declared by the customer or obtained from a cookie that is loaded onto the client device 10.

The visit parameter set generated at block 42 is augmented with the target parameters extracted at block 40 (block 44). Typically the browser 12 or web/content server 14 augments the visit parameter set with the target parameter into an augmented visit parameter set. The redirect is then constructed with the augmented visit parameter set (block 46) by the web/content server 14. Upon execution of the redirect command by the browser 12 or web/content server 14, the augmented visit parameter set is sent to the ad server 18, where the ad server determines at least one target-able ad from the campaign database 20 (block 48).

The target-able ad contains one or more offers that offer competitive fares compared to the fares generated from the original search request. In one embodiment of the present invention, the target-able ad includes one or more offers of travel itineraries with lowest fares (i.e., fare-match offers). For example, if the search results return an itinerary on Airtran for $109 and American Airlines for $120, there may be an offer from Delta with a fare of $105 rendered through the target-able ad. The user could be presented with more than one option in the target-able ad, offering the lower fares from a single airline or multiple airlines. The offers in the target-able ads could also be from retailers rather than from the suppliers.

In addition, the offers could be pre-built and stored within the campaign database 20, or the offers could be generated dynamically as a function of consumer demand or other factors, such as session-level characteristics. The campaign database 20 could be maintained by a service that is responsible for entering the terms and conditions of the offers (e.g., price), as well as monitoring how and when each offer should be included in a target-able ad.

The offers are then included in at least one target-able ad based on the information in the augmented visit parameter set. There could be any number of offers included in the target-able ad, and each offer is chosen based on one or more target criteria (described above) located in the augmented visit parameter set. For instance, all of the offers having the same or lower fare than the fares returned from the search engine 16 could be included in the target-able ad. The target-able ad is transmitted to the browser 12 (block 50) to be presented on the client device 10 (block 52). The target-based ads could be metered by the ad server 18 to resolve any conflicts that may arise, where metering involves rotating ad rendering across multiple competing offers to achieve impression, click, or sales goals for each offer. The target-based ad could be presented within the original search results as an additional option, or the ad could be presented on the same screen as the original search results in a separate image or window or in textual form, as described above. If the user selects a particular offer from the target-based ad, the user could continue the transaction on the existing web page, or the user could be directed or linked to a new web page for booking or obtaining additional information about the itinerary upon which the selected offer was based.

According to one aspect of the present invention, the system generally operates under control of a computer program product. The computer program product for performing the methods of embodiments of the present invention includes a computer-readable storage medium, such as the memory device associated with a processing element, and computer-readable program code portions, such as a series of computer instructions, embodied in the computer-readable storage medium. In this regard, FIGS. 2-4 are control flow diagrams of methods and program products according to the invention. It will be understood that each block or step of the control flow diagrams, and combinations of blocks in the control flow diagrams, can be implemented by computer program instructions. These computer program instructions may be loaded onto a processing element, such as a computer, server, or other programmable apparatus, to produce a machine, such that the instructions which execute on the processing element create means for implementing the functions specified in the block(s) or step(s) of the control flow diagrams. These computer program instructions may also be stored in a computer-readable memory that can direct the processing element to function in a particular manner, such that the instructions stored in the computer-readable memory produce an article of manufacture including instruction means which implement the function specified in the block(s) or step(s) of the control flow diagrams. The computer program instructions may also be loaded onto the processing element to cause a series of operational steps to be performed on the processing element to produce a computer implemented process such that the instructions which execute on the processing element provide steps for implementing the functions specified in the block(s) or step(s) of the control flow diagrams.

Accordingly, blocks or steps of the control flow diagrams support combinations of means for performing the specified functions, combinations of steps for performing the specified functions, and program instruction means for performing the specified functions. It will also be understood that each block or step of the control flow diagrams, and combinations of blocks or steps in the control flow diagrams, can be implemented by special purpose hardware-based computer systems which perform the specified functions or steps, or combinations of special purpose hardware and computer instructions.

Therefore, the system of the present invention is capable of generating target-based ads that include prices that are either competitive, equal, or lower than the prices generated for the original search results. With respect to the airline industry, for example, the offers could be regularly loaded into the campaign database, where the target-based ads include offers having fares for partner airlines. The lower or equal fares could be a sale fare of an itinerary for an airline presented with the search results from the search engine 16 and/or an itinerary for an airline having a competitive or lower fare from the target-able ads. In this regard, the target-based ads may be generated dynamically and in real-time such that the user is presented with additional options satisfying the user's travel preferences. In particular, the user may be presented with additional fares for an itinerary that is part of results of the user's search request.

Because the user is presented with more low fare options with one or more fares provided via the search results and one or more fares provided by the target-able ads, there is an increased probability of session-to-book conversion. As such, advertisers may be more willing to provide targeted offers through the ad server. Computerized reservation services, such as Travelocity.com, would be capable of generating revenue not only from an increased number of bookings but also from targeted advertising. For instance, since targeted advertising increases the value of CPM ads, suppliers could be charged a premium for each offer, and conflicts could be resolved with metering on the ad server. Since these are sales that the suppliers, such as airlines, would not have made otherwise, the suppliers may be more willing to pay a premium for the offers included in the target-based ads. The enhanced fee could be incorporated into the CPM premium.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for providing pricing through advertising comprising the steps of:
generating at least one search result satisfying a user request;
generating a visit parameter set in response to the request;
augmenting the visit parameter set with at least one target parameter extracted from the search result to create an augmented visit parameter set; and
providing at least one target-able ad that is selected based on the augmented visit parameter set.

2. The method according to claim 1, further comprising receiving a request including at least one travel preference, and wherein the travel preference comprises at least one of departure and return dates, an origin location, a destination location, and a price range.

3. The method according to claim 1, further comprising constructing a redirect command including the augmented visit parameter set.

4. The method according to claim 3, further comprising:
providing the redirect command along with the augmented visit parameter set;
executing the redirect command;
determining the at least one target-able ad based on the augmented visit parameter set; and
providing the target-able ad along with the search result.

5. The method according to claim 1, wherein the at least one target parameter comprises at least one of a lowest fare, number of lowest fare instances, carriers offering the lowest fare, origin and destination, requested departure time and date, requested arrival time and date, displacement times of the lowest fares, service quality of the lowest fare product, and elapsed time of the lowest fares.

6. The method according to claim 1, wherein generating the at least one search result comprises generating a search result having an associated fare.

7. The method according to claim 6, wherein determining the at least one target-able ad comprises determining a set of campaigns with each campaign including one or more offers.

8. The method according to claim 7, wherein the set of campaigns comprises at least one offer including a lower or equal associated fare than the associated fare of the at least one search result.

9. The method according to claim 1, wherein generating the visit parameter set comprises generating a visit parameter set having at least one of a plurality of session-based target parameters and a plurality of customer-based target parameters.

10. A computer-readable medium containing instructions for causing a computing device to perform the steps of:
generating at least one search result satisfying a user request;
generating a visit parameter set in response to the request;
augmenting the visit parameter set with at least one target parameter extracted from the search result to create an augmented visit parameter set; and
providing at least one target-able ad that is selected based on the augmented visit parameter set.

11. The computer-readable medium according to claim 10, further comprising receiving a request including at least one travel preference, and wherein the travel preference comprises at least one of departure and return dates, an origin location, a destination location, and price range.

12. The computer-readable medium according to claim 10, further comprising constructing a redirect command including the augmented visit parameter set.

13. The computer-readable medium according to claim 12, further comprising:
providing a redirect command along with the augmented visit parameter set;
executing the redirect command;
determining the at least one target-able ad based on the augmented visit parameter set; and
providing the target-able ad along with the search results.

14. The computer-readable medium according to claim 10, wherein the at least one target parameter comprises at least one of a lowest fare, number of lowest fare instances, carriers offering the lowest fare, origin and destination, requested departure time and date, requested arrival time and date, displacement times of the lowest fares, service quality of the lowest fare product, and elapsed time of the lowest fares.

15. The computer-readable medium according to claim 10, wherein generating the at least one search result comprises generating a search result having an associated fare.

16. The computer-readable medium according to claim 15, wherein determining the at least one target-able ad comprises determining a set of campaigns with each campaign including one or more offers.

17. The computer-readable medium according to claim 16, wherein the set of campaigns comprises at least one offer including a lower or equal associated fare than the associated fare of the at least one search result.

18. The computer-readable medium according to claim 10, wherein generating the visit parameter set comprises generating a visit parameter set having at least one of a plurality of session-based target parameters and a plurality of customer-based target parameters.

19. A system for providing fares for pricing through advertising comprising:
a client device to receive a user request;
at least one processing element to generate at least one search result satisfying the request, extract at least one target parameter from the search result, generate a visit parameter set in response to the request, and augment the visit parameter set with the target parameter from the search result to create an augmented visit parameter set; and
an ad server to receive the augmented visit parameter set, determine at least one target-able ad based on the augmented visit parameter set, and transmit the target-able ad to be displayed at the client device.

20. The system according to claim 19, wherein the at least one processing element comprises:
at least one server to generate the at least one search result satisfying the request, and extract the at least one target parameter from the search result; and
a browser element to generate the visit parameter set in response to the request, and augment the visit parameter set with the target parameter into an augmented visit parameter set.

21. The system according to claim 20, wherein the at least one processing element comprises:
a first server to generate the at least one search result satisfying the request; and
a second server to extract the at least one target parameter from the search result.

22. The system according to claim 19, further comprising a campaign database including at least one offer, wherein the ad server is capable of accessing the campaign database to obtain at least one offer to include in the target-able ad.

23. A method for providing fares for travel through targeted advertising comprising the steps, performed by a processor, of:
generating at least one search result having an associated fare and satisfying a user request;
generating a visit parameter set in response to the request;
augmenting the visit parameter set with at least one target parameter extracted from the search result to create an augmented visit parameter set; and
providing at least one offer having an associated fare that is selected based on the augmented visit parameter set.

24. The method according to claim 23, wherein providing comprises providing the offer in at least one target-able ad along with the search result.

25. The method according to claim 23, wherein each of the search result and offer comprises at least one respective travel itinerary.

26. The method according to claim 23, wherein the associated fare of the at least one offer is lower than or equal to the associated fare of the search result.

27. The method according to claim 23, wherein the at least one target parameter comprises at least one of a lowest fare, number of lowest fare instances, carriers offering the lowest fare, origin and destination, requested departure time and date, requested arrival time and date, displacement times of the lowest fares, service quality of the lowest fare product, and elapsed time of the lowest fares.

28. An apparatus for providing fares for pricing through advertising comprising:
at least one processing element to generate at least one search result satisfying a user request, extract at least one target parameter from the search result that defines at least one characteristic of the search result, and then construct a redirect command to facilitate subsequent generation of an ad based on the characteristic defined by the target parameter.

29. The apparatus according to claim 28, wherein the at least processing element comprises:
a first server to generate the at least one search result satisfying the request, and construct the redirect command to facilitate subsequent generation of the ad based on the characteristic defined by the target parameter; and
a second server to extract the at least one target parameter from the search result that defines the at least one characteristic of the search result.

30. A method for providing fares for pricing through advertising comprising:
generating at least one search result satisfying a user request;
extracting at least one target parameter from the search result that defines at least one characteristic of the search result; and
constructing a redirect command to facilitate subsequent generation of an ad based on the characteristic defined by the target parameter.

31. The method according to claim 30, further comprising:
providing the redirect command along with the search result; and
executing the redirect command.

32. An apparatus for providing pricing through advertising comprising:
a processing element to receive a visit parameter set augmented with at least one target parameter, determine at least one offer having an associated price based on the augmented visit parameter set including the target parameter, and provide the offer in at least one target-able ad.

33. The apparatus according to claim 32, further comprising a campaign database including the at least one offer, wherein the ad server is capable of accessing the campaign database to obtain the at least one offer to include in the target-able ad.

34. The apparatus according to claim 32, wherein the price comprises a fare that is associated with a travel itinerary.

35. The apparatus according to claim 32, wherein the processing element is an ad server.

36. A method for providing fares for pricing through advertising comprising:
receiving a visit parameter set augmented with at least one target parameter;
determining at least one offer having an associated price based on the augmented visit parameter set including the target parameter; and
providing the offer in at least one target-able ad.

37. The method according to claim 36, wherein the price comprises a fare that is associated with a travel itinerary.

38. The method according to claim 36, wherein the at least one target parameter comprises at least one of a lowest fare, number of lowest fare instances, carriers offering the lowest fare, origin and destination, requested departure time and date, requested arrival time and date, displacement times of the lowest fares, service quality of the lowest fare product, and elapsed time of the lowest fares.
